(19) United States
(12) Patent Application Publication
(10) Pub. No.: US 2017/0191716 A1
(43) Pub. Date: Jul. 6, 2017

(54) CONTROLLING TEMPERATURE USING AN UNLOADER MANIFOLD

(71) Applicant: THERMO KING CORPORATION, Minneapolis, MN (US)

(72) Inventors: Daniel L. PRICE, Bloomington, MN (US); Panayu Robert SRICHAI, Minneapolis, MN (US); Lee J. ERICKSON, Eagan, MN (US)

(21) Appl. No.: 15/394,218

(22) Filed: Dec. 29, 2016

Related U.S. Application Data
(60) Provisional application No. 62/273,665, filed on Dec. 31, 2015.

(51) Int. Cl. F25B 41/04; F25B 49/02; B60P 3/20

(52) U.S. Cl. CPC F25B 41/04; B60P 3/205; F25B 49/022; F25B 2400/074; F25B 2400/077; F25B 2500/06

(57) ABSTRACT

A transport refrigeration system (TRS) and method of controlling temperature using an unloader manifold. The TRS includes a heat transfer circuit, the heat transfer circuit includes a compressor with a first cylinder bank and a second cylinder bank, and an unloader manifold with a first end connected to the first and second cylinder bank and a second end connected to a hot gas line in the heat transfer circuit. The first and second cylinder banks and the hot gas line are in fluid communication via the unloader manifold such that a heat transfer fluid can flow therethrough. The TRS further includes an unloader discharge controller to unload, via the unloader manifold, heat transfer fluid from the first cylinder bank to a first discharge level.

### FIELD

This disclosure relates generally to a transport refrigeration system (TRS). More specifically, this disclosure relates to systems and methods in a TRS for controlling temperature using an unloader manifold.

### BACKGROUND

A transport refrigeration system (TRS) is generally used to control one or more environmental conditions such as, but not limited to, temperature, humidity, and/or air quality of a transport unit. Examples of transport units include, but are not limited to, a container (e.g., container on a flat car, an intermodal container, etc.), a truck, a boxcar, or other similar transport units. A refrigerated transport unit is commonly used to transport perishable items such as produce, frozen foods, and meat products.

Generally, the refrigerated transport unit includes a transport unit and a TRS. The IRS includes a transport refrigeration unit (TRU) that is attached to the transport unit to control one or more environmental conditions (e.g., temperature, humidity, etc.) of a particular space (e.g., a cargo space, an interior space, a passenger space, etc.) (generally referred to as a “conditioned space”). The TRU can include, without limitation, a compressor, a condenser, an expansion valve, an evaporator, and fans or blowers to control the heat exchange between the air inside the conditioned space and the ambient air outside of the refrigerated transport unit.

### SUMMARY

This disclosure relates generally to a transport refrigeration system (TRS). More specifically, this disclosure relates to systems and methods in a TRS for controlling temperature using an unloader manifold.

In some embodiments, a TRS includes an unloader manifold connected to a first cylinder bank and a second cylinder bank of a compressor, which can be unloaded by the unloader manifold based on a cooling requirement of the TRS. An unloader manifold, as used herein, can have a plurality of pipes, chambers, and/or openings for fluid travel. In some embodiments, the unloader manifold can include a first end connected to the first and second cylinder banks and a second end connected to a hot gas line in the transport refrigeration system.

In some embodiments, the unloader manifold can unload both the first and second cylinder banks in a particular order and/or to a particular capacity based on a cooling requirement of the TRS. For example, the unloader manifold can discharge, based on a cooling requirement of the TRS, heat transfer fluid from the second cylinder bank to a particular level to cool the hot gas line after the first cylinder is discharged to a first level. The unloader manifold can further discharge, based on the cooling requirement of the TRS, heat transfer fluid from the first cylinder bank to a second level to cool the hot gas line after the second cylinder bank is discharged to the particular level.

A method of controlling temperature using an unloader manifold in a transport refrigeration system (TRS) can provide variable capacity control from 100% loaded down to 0% loaded conditions. That is, each respective cylinder bank (e.g., first and second) can be unloaded to a particular amount and/or completely (e.g., empty). The variable capacity control via the unloader manifold can provide a cool running compressor with improved oil return from the system, and provide for increased reliability.

Additionally, or alternatively, in some embodiments, the unloader manifold capacity control can provide the compressor fluid transfer fluid to the hot gas line, which can cause the compressor to operate at a cooler temperature, and can increase the performance and efficiency of the TRS. Further, capacity unloading heat transfer fluid from the first and/or second cylinder banks in a compressor directed to the hot gas line can result in a reduction in fuel consumption when operating in a continuous run control mode.

A TRS is disclosed. The TRS includes a heat transfer circuit. The heat transfer circuit includes a compressor, a condenser, an expansion device, an evaporator, and an unloader manifold. The compressor, the condenser, the expansion device, the evaporator, and the unloader manifold are in fluid communication such that a heat transfer fluid can flow therethrough. An unloader manifold is configured to discharge, based on a cooling requirement of TRS, heat transfer fluid from a first cylinder bank to a first level to cool the hot gas line before discharging heat transfer fluid from a second cylinder bank.

A method of controlling temperature using an unloader manifold in a TRS is disclosed. The method includes discharging, to a first level, heat transfer fluid from a first cylinder bank associated with a compressor. The method further includes discharging heat transfer fluid from a second cylinder bank associated with the compressor after the first cylinder bank is discharged to the first level, and directing the heat transfer fluid to a hot gas line in the transport refrigeration system.

### BRIEF DESCRIPTION OF THE DRAWINGS

References are made to the accompanying drawings that form a part of this disclosure, and which illustrate the embodiments in which the systems and methods described in this Specification can be practiced.

FIG. 1 illustrates a side view of a refrigerated transport unit, according to an embodiment.

FIG. 2 illustrates a schematic diagram of a transport refrigeration unit (TRU), according to an embodiment.

FIG. 3 illustrates an unloader manifold to control discharge temperature of a heat transfer fluid discharged from a compressor in a TRS, according to an embodiment.

FIG. 4 illustrates a flow diagram of an unloader manifold to control discharge temperature of a heat transfer fluid discharged from a compressor in a TRS, according to an embodiment.

Like reference numbers represent like parts throughout.

### DETAILED DESCRIPTION

This disclosure relates generally to a transport refrigeration system (TRS). More specifically, this disclosure relates to systems and methods for controlling temperature using an unloader manifold in a TRS.

A TRS can include a heat transfer circuit. The heat transfer circuit can include a compressor with a first cylinder bank and a second cylinder bank. In some embodiments, the heat transfer circuit can include an unloader manifold that can have a first end connected to the first and second cylinder bank and a second end connected to a hot gas line in the heat transfer circuit.

The first and second cylinder banks and the hot gas line can be in fluid communication via the unloader manifold such that a heat transfer fluid can flow therethrough. In some embodiments, the TRS can include an unloader discharge controller to unload, via the unloader manifold, heat transfer fluid from the first cylinder bank to a first discharge level.

The unloader manifold can generally be used to provide heat transfer fluid from the first and/or second cylinder banks from the compressor to the hot gas line. This is generally accomplished by using variable capacity to unload heat transfer fluid from the compressor (e.g., first and second cylinder banks) to the hot gas line. The unloader manifold and the heat transfer fluid it provides directly to the hot gas line via a manifold connection can increase the performance and efficiency of the TRS.

A TRS is generally used to control one or more environmental conditions such as, but not limited to, temperature, humidity, and/or air quality of a refrigerated transport unit. Examples of refrigerated transport units include, but are not limited to, a container on a flat car, an intermodal container, a truck, a boxcar, or other similar transport units. A refrigerated transport unit can be used to transport perishable items such as, but not limited to, produce, frozen foods, and meat products.

As disclosed in this Specification, a TRS can include a transport refrigeration unit (TRU) which is attached to a transport unit to control one or more environmental conditions (e.g., temperature, humidity, air quality, etc.) of an interior space of the refrigerated transport unit. The TRU can include, without limitation, a compressor, a condenser, an expansion valve, an evaporator, and one or more fans or blowers to control the heat exchange between the air within the interior space and the ambient air outside of the refrigerated transport unit.

A “transport unit” includes, for example, a container on a flat car, an intermodal container, truck, a boxcar, or other similar transport unit.

A “transport refrigeration system” (TRS) includes, for example, a refrigeration system for controlling the refrigeration of an interior space of a refrigerated transport unit. The TRS may include a vapor-compressor type refrigeration system, a thermal accumulator type system, or any other suitable refrigeration system that can use refrigerant, cold plate technology, or the like.

A “refrigerated transport unit” includes, for example, a transport unit having a TRS.

Embodiments of this disclosure may be used in any suitable environmentally controlled transport apparatus, such as, but not limited to, a shipboard container, an air cargo cabin, and an over the road truck cabin.

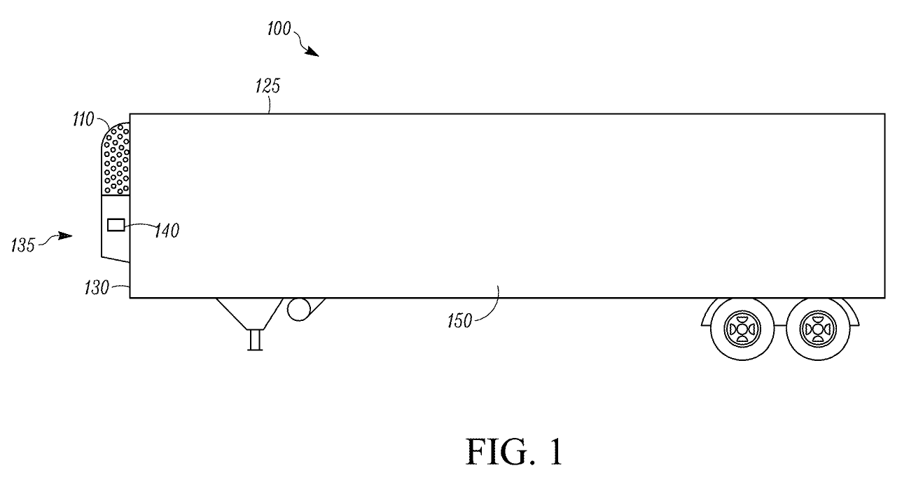

FIG. 1 illustrates a side view of a TRS 100 for a transport unit 125, according to some embodiments. The illustrated transport unit 125 is a trailer-type transport unit. Embodiments as described in this Specification can be used with other types of transport units. For example, the transport unit 125 can represent a container (e.g., a container on a flat car, an intermodal container, etc.), a truck, a boxcar, or other similar type of refrigerated transport unit including an environmentally controlled interior space.

The TRS 100 is configured to control one or more environmental conditions such as, but not limited to, temperature, humidity, and/or air quality of an interior space 150 of the transport unit 125. In some embodiments, the interior space 150 can alternatively be referred to as the conditioned space 150, the cargo space 150, the environmentally controlled space 150, or the like. In particular, the TRS 100 is configured to transfer heat between the air inside the interior space 150 and the ambient air outside of the transport unit 125.

The interior space 150 can include one or more partitions or internal walls (not shown) for at least partially dividing the interior space 150 into a plurality of zones or compartments, according to some embodiments. It is to be appreciated that the interior space 150 may be divided into any number of zones and in any configuration that is suitable for controlling one or more environmental conditions of the different zones. In some examples, each of the zones can have a set point temperature that is the same or different from one another.

The TRS 100 includes a transport refrigeration unit (TRU) 110. The TRU 110 is provided on a front wall 130 of the transport unit 125. The TRU 110 can include a prime mover (e.g., an internal combustion engine) (not shown) that provides mechanical power directly to a component (e.g., a compressor, etc.) of the TRS 100. In some embodiments, the prime mover of the TRU 110 can provide power directly to an alternator (not shown), which can be used to power the component. In such embodiments, the TRU 110 can include an electric drive motor that provides mechanical power directly to the component (e.g., a compressor, etc.) of the TRS 100.

Also, in some embodiments, the internal combustion engine can generally include a cooling system (e.g., water or liquid coolant system), an oil lubrication system, and an electrical system. An air filtration system can filter air directed into a combustion chamber of the engine.

In some embodiments, the engine is not specifically configured for the TRS 100, but can be a non-industrial internal combustion engine, such as an automotive internal combustion engine.

The TRU 110 includes a programmable TRS Controller 135 that includes a single integrated control unit 140. It is to be appreciated that, in some embodiments, The TRS controller 135 may include a distributed network of TRS control elements (not shown). The number of distributed control elements in a given network can depend upon the particular application of the principles described in this Specification. The TRS Controller 135 can include a processor, a memory, a clock, and an input/output (I/O) interface (not shown). The TRS Controller 135 can include fewer or additional components.

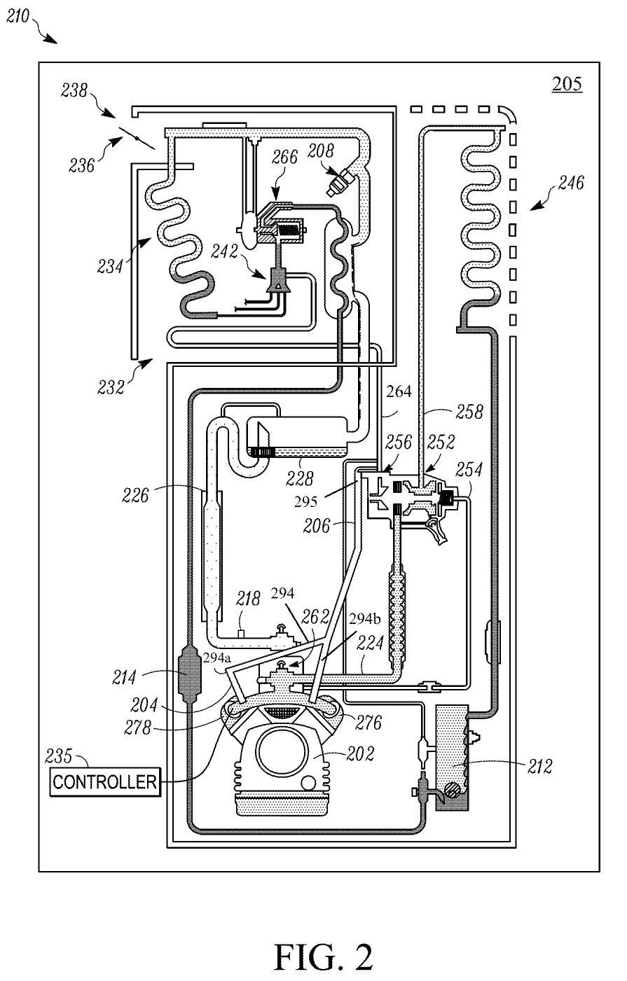

The TRU 110 also includes a heat transfer circuit (as shown and described in FIG. 2). Generally, the TRS Controller 135 is configured to control a heat transfer cycle (e.g., controlling the heat transfer circuit of the TRU 110) of the TRS 100. In one example, the TRS Controller 135 controls the heat transfer cycle of the TRS 100 to obtain various operating conditions (e.g., temperature, humidity, air quality etc.) of the interior space 150.

FIG. 2 illustrates a schematic diagram of a heat transfer circuit 205 disposed within a transport refrigeration unit (TRU) 210 (e.g., the TRU 110 shown in FIG. 1), according to an embodiment. The TRU 210 generally includes a compressor 202, a condenser 246, a receiver tank 212, a dryer 214, an expansion device 266, a distributor 242, an evaporator 234, and an accumulator tank 228. As illustrated, the compressor 202 can include a discharge port 262, a first cylinder bank 276 and a second cylinder bank 278. An unloader manifold 204 is connected to the first cylinder bank 276, the second cylinder bank 278, and a hot gas line 256 via a manifold connection 206. The manifold connection 206 is a part of the unloader manifold 204. For example, the first end 294 of the unloader manifold 204 can include a first line and a second line that connect at the manifold connection 206. As used herein, the manifold connection 206 can be a second end of the unloader manifold 204. The manifold connection 206 is connected to the hot gas line 256. The components of the TRU 210 are connected in fluid communication to form the heat transfer circuit 205 for the TRU 210.

The compressor 202 can be driven by a prime mover (not shown). In some embodiments, the prime mover can include an internal combustion engine coupled to the compressor 202 to provide mechanical power directly to the compressor 202. In some embodiments, an internal combustion engine can provide mechanical power to, for example, an alternator, generator, or the like, which in turn provides electric power to an electric drive motor, which is coupled to the compressor 202 to provide mechanical power to the compressor 202. In some embodiments, the TRU 210 can include a combination of an internal combustion engine and an electric drive motor and can be configured to use the internal combustion engine alone or the electric drive motor alone. In some embodiments, the TRU 210 can be an electrically driven compressor. In some embodiments, the TRU 210 can include a combination of an internal combustion engine and an electric drive motor and can be configured to use a combination thereof (e.g., both are operating at the about the same time to power the various components of the TRU 210).

The TRU 210 includes a hot-gas bypass that is configured to provide high-pressure heat transfer fluid directly to the low-pressure side of the heat transfer circuit 205. That is, the hot-gas bypass can divert high-pressure heat transfer fluid such that it is not directed to the condenser 246, but instead is directed to the distributor 242.

The high-pressure gas heat transfer fluid can be discharged from the compressor 202 and provided to the condenser 246 via a discharge line 224 and an outlet port 258. The outlet port 258 can direct the heat transfer fluid to the condenser 246. The high-pressure gas is changed from a high-pressure gas to a high-pressure liquid as it flows through the condenser 246. The high-pressure liquid flows into the receiver tank 212. In accordance with known principles, the high-pressure liquid accumulates in the receiver tank 212 and the liquid portion is passed through the dryer 214.

The liquid heat transfer fluid can flow from the dryer 214 to the expansion device 266. The expansion device 266 expands the liquid heat transfer fluid into a two-phase heat transfer fluid and is distributed into the evaporator 234 through the distributor 242. The heat transfer fluid can exchange heat with, for example, indoor air in a transport unit (e.g., the transport unit 125 of FIG. 1).

The unloader manifold 204 can have a first end 294 connected to the first cylinder bank 276 and second cylinder bank 278 of the compressor 202. The unloader manifold 204 can have a second end (e.g., the manifold connection 206) connected to a hot gas line 256 via the manifold connection 206. That is, the unloader manifold 204 can fluidly connect the respective cylinder banks 276, 278 with the hot gas line 256. The hot gas line 256 can include a flow control device 252, which can, for example, direct flow of the heat transfer fluid and/or be a three-way valve in some embodiments. The flow control device 252 can direct flow to the outlet port 258 to the condenser 246, a line 254 to a suction side of the compressor 202, and/or a line 264 to the distributor 242.

The unloader manifold 204 can be controlled by a controller 235 (such as, for example, the TRS Controller 135 shown in FIG. 1) to control capacity variance of the first and second cylinder banks 276, 278. The first end 294 of the unloader manifold 204 can include a plurality of ports 294a, 294b connected to the first cylinder bank 276 and the second cylinder bank 278 of the compressor 202. The second end (e.g., the manifold connection 206) 295 of the unloader manifold 204 is connected to the hot gas line 256. The unloader manifold 204 can unload, from the compressor 202, the first cylinder bank 276 to a first level based on a cooling requirement of the TRS before unloading a second cylinder bank 278 to a particular level. The unloader manifold 204 can unload heat transfer fluid from the respective cylinder bank (e.g., 276, 278), which can be directed to the hot gas line 256 via the manifold connection 206.

In some embodiments, the unloader manifold 204 can control an amount of heat transfer fluid discharged from a respective cylinder bank (e.g., 276, 278). For example, the TRS may have a cooling requirement of ˜80% of the heat transfer fluid from the cylinder banks 276, 278. The unloader manifold 204 can unload heat transfer fluid from the first cylinder bank 276 to a first level, (e.g., ˜50%). The unloader manifold 204 can unload heat transfer fluid from the second cylinder bank 278 to a particular level (e.g., 30%) before returning to unload the first cylinder bank 276 to a second level. The amount of heat transfer fluid unloaded from the respective cylinder banks 276, 278 can be based on a cooling requirement of the TRS. That is, in one embodiment, the first cylinder bank 276 being unloaded to a first level may provide enough heat transfer fluid for adequate cooling when a cooling requirement is low. Additionally, or alternatively, the first cylinder bank 276 unloaded to a first level may not provide adequate cooling when a higher cooling requirement is required, at which point the second cylinder bank 278 can be unloaded to a particular level (e.g., 0%-100%).

In some embodiments, the heat transfer fluid from the unloaded cylinder banks (e.g., 276, 278) can be routed to the hot gas line 256 rather than routed back to the compressor suction. In the illustrated embodiment, the manifold connection 206 connects to the hot-gas line 256. The manifold connection 206 can divert high-pressure gas heat transfer fluid from the first cylinder bank 276 and/or the second cylinder bank 278 of the compressor 202 via the unloader manifold 204 to the distributor 242. As illustrated in FIG. 2, the heat transfer fluid from the manifold connect 206 can travel to the hot gas bypass and through a line 264 to the distributor 242. By routing the heat transfer fluid to the hot gas line 256, the compressor 202 can operate at a cooler temperature, which can prevent the pistons from getting hot and seizing. Additionally, or alternatively, an adequate amount or a surplus of oil can be returned to the TRU, which can prevent lack of lubrication failures within the compressor 202.

A method of controlling temperature using an unloader manifold in a transport refrigeration system (TRS) can include, in some embodiments, discharging, to a first level, heat transfer fluid from a first cylinder bank 276 associated with the compressor 204. That is, the unloader manifold can vary the discharge capacity of the first cylinder bank 276.

Additionally, or alternatively, the method can include discharging heat transfer fluid from a second cylinder bank 278 associated with the compressor 204 after the first cylinder bank 276 is discharged to the first level. That is, in some embodiments, the second cylinder bank 278 can be discharged once the first cylinder bank 276 has been discharged to a first level. For example, a cooling requirement of the TRS may be adequately cooled by discharging the first cylinder bank 276 several times. For instance, the unloader manifold 204 may discharge the first cylinder bank 276 from 100% to ˜80%. The unloader manifold 204 may again discharge the first cylinder bank 276 from ˜80% to ˜50% before switching to discharge the second cylinder bank 278.

In some embodiments, the method can include directing the heat transfer fluid to a hot gas line 256 in the TRS. Directing the heat transfer fluid to the hot gas line 256 can cool the TRU 210, while increasing efficiency and oil return to the compressor 202. In some embodiments, connecting the unloader manifold 204 can eliminate the hot gas bypass valve. That is, the unloader manifold 204 includes a manifold connection 206 directly to the hot gas line 256, which can eliminate the need of a hot gas bypass valve in the TRU 210.

In some embodiments, the method can include discharging, to a second, level, heat transfer fluid from the first cylinder bank after the second cylinder bank is discharged, where discharging to the second level is based on a cooling requirement of the TRS. Additionally, or alternatively, discharging the second cylinder bank can be based on a cooling requirement associated with the TRS.

The TRU 210 can include one or more sensors (e.g., a discharge temperature sensor (not shown), a discharge pressure sensor (not shown), a suction pressure sensor 226, a suction temperature sensor 218, or the like). The sensors, for example, can sense the discharge level of the first cylinder bank 276 and the second cylinder bank 278. That is, the sensors can determine when a respective cylinder bank has been discharged of heat transfer fluid to a first, second, or particular level.

It is to be appreciated that the TRU 210 can include fewer or additional components than illustrated in FIG. 2. For example, one or more condenser fans or blowers (not shown), can force ambient air through the condenser 246. Similarly, one or more evaporator fans or blowers (not shown), can draw air (generally referred to as return air) from an interior space (e.g., the interior space 150 of FIG. 1) of a transport unit (e.g., the transport unit 125 of FIG. 1) through an air inlet 232. The conditioned air can be discharged by one or more fans or blowers (not shown) into the interior space (e.g., the interior space 150 of FIG. 1) through an air outlet 238. A damper 236 can be configured to control an amount of air discharged from the air outlet 238. The positioning of the damper 236 can also, for example, be modified to prevent air from being discharged into the interior space from the air outlet 238 under certain conditions (e.g., during a defrost cycle, etc.).

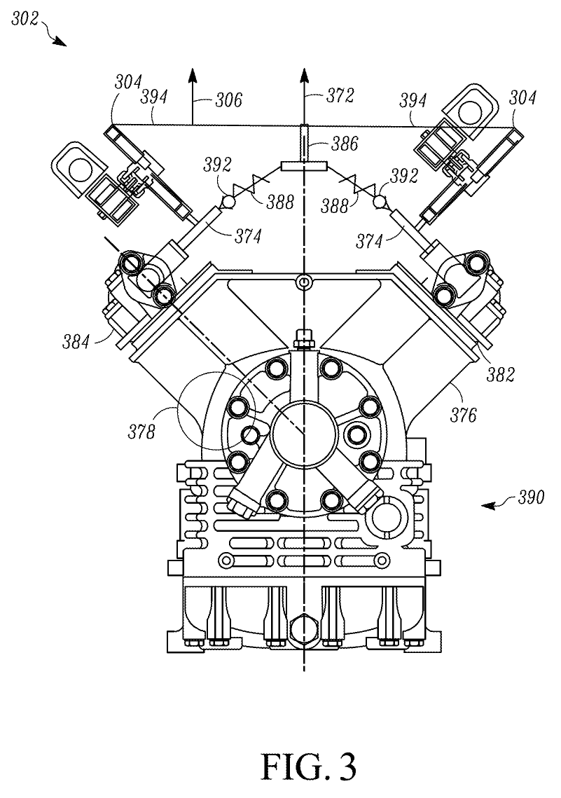

FIG. 3 illustrates an unloader manifold 304 to control discharge temperature of a heat transfer fluid discharged from a compressor 302 in a TRS, according to one embodiment. As illustrated in FIG. 3, the compressor 302 includes a compressor body 390, a first cylinder bank 376, a second cylinder bank 378, a first cylinder head 382, and a second cylinder head 384.

Similar to FIG. 2, discussed above, the unloader manifold 304 in a TRS is connected to the first cylinder bank 376 (e.g., a front cylinder bank) and the second cylinder bank 378 (e.g., a back cylinder bank) of the compressor 302. The unloader manifold 304 can have a first end 394 that is connected to the first 376 and the second cylinder bank 378, while a second end 306 can be connected to a hot gas line (e.g., the hot gas line 256 shown in FIG. 2) in the TRS. That is, the first end 394 of the unloader manifold 304 can be connected to the first cylinder bank 376 and/or the second cylinder bank 378, while the second end 306 of the unloader manifold 304 is connected to the hot gas line in the TRS. In some embodiments, the unloader manifold 304 can be configured to discharge, based on a cooling requirement of the TRS, heat transfer fluid from the first cylinder bank 376 to a first level to cool the hot gas line.

The unloader manifold 304 can, in some embodiments, discharge, based on the cooling requirement of the TRS, heat transfer fluid from the second cylinder bank 378 to a particular level to cool the hot gas line after the first cylinder bank 376 can be discharged to the first level. That is, the first cylinder bank 376 can be discharged by the unloader manifold 304 before the second cylinder bank 378 is discharged. In other words, the unloader manifold 304 can vary the capacity (e.g., the amount of heat transfer fluid) that is discharged from a respective cylinder bank before discharging a different cylinder bank.

In some embodiments, the unloader manifold 304 can discharge, based on a cooling requirement of the TRS, heat transfer fluid from the first cylinder bank 376 to a second level to cool the hot gas line after the second cylinder bank 378 is discharged to the particular level. That is, the unloader manifold 304 can discharge the second cylinder bank 378 to a particular level (e.g., 0%, unload completely) before returning to unload the first cylinder bank 376 to a second level (e.g., below ˜50%). The unloader manifold 304 can unload the respective cylinder bank (e.g., 376, 378) via capacity variance based on a cooling requirement of the TRS.

In some embodiments, the compressor 302 can include a check valve 388 and a solenoid valve 392 associated with the first and/or second cylinder head 382, 384 to provide durability when the first cylinder bank 376 and/or second cylinder bank 378 is unloaded. In some embodiments, the first and the second cylinder head 382, 384 can include a respective solenoid valve 392, which can be connected.

The first cylinder head 382 and the second cylinder head 384 can include a respective fitting 374 that is associated with the respective check valve 388 and the solenoid valve 392. In some embodiments, the fitting 374 can be a “T” fitting and/or made of copper material. The fitting 374 and the check valve 388, in some embodiments, can be connected such that a heat transfer fluid can flow to a discharge service valve 372. The discharge service valve 372 is a valve that controls whether heat transfer fluid travels past the discharge service valve 372. In some embodiments, the discharge service valve 372 can include an on or off position. Setting the discharge service valve 372 to an on position enables heat transfer fluid to flow past the discharge service valve 372 and into the discharge port (e.g., 262 in FIG. 2) and through the discharge line (e.g., 224 in FIG. 2) and connect to the flow control device (e.g., 252 in FIG. 2) and may be directed to the hot gas line (e.g., 256 in FIG. 2) and/or the outlet port (e.g., 258 in FIG. 2).

Additionally or alternatively, in some embodiments, the discharge service valve 372 can be set to an off position, thereby preventing heat transfer fluid to flow past the discharge service valve 372. Preventing heat transfer fluid from flowing past the discharge service valve 372 can direct the heat transfer fluid to stay in the first cylinder bank 376 and/or the second cylinder bank 378 and/or flow through the unloader manifold 304, through the second end 306, and thereby connecting directly to the hot gas line (e.g., 256 in FIG. 2), as previously discussed herein.

In some embodiments, setting the discharge service valve 372 to an on position can allow heat transfer fluid to flow past the discharge service valve 372, as previously discussed, and allow heat transfer fluid to flow into the unloader manifold 304 and to the hot got gas line via the second end 306, as previously discussed. That is, setting the discharge service valve 372 to an on position can, in some embodiments, allow heat transfer fluid to flow past the discharge service valve 372 and to the unloader manifold 304.

In some embodiments, the first cylinder bank 376 can be unloaded by use of rapid cycling during a continuous run modulation. The fitting 374 associated with the check valve 388 and the solenoid valve 392 can reduce compressor power during conditions of low speed continuous run modulation.

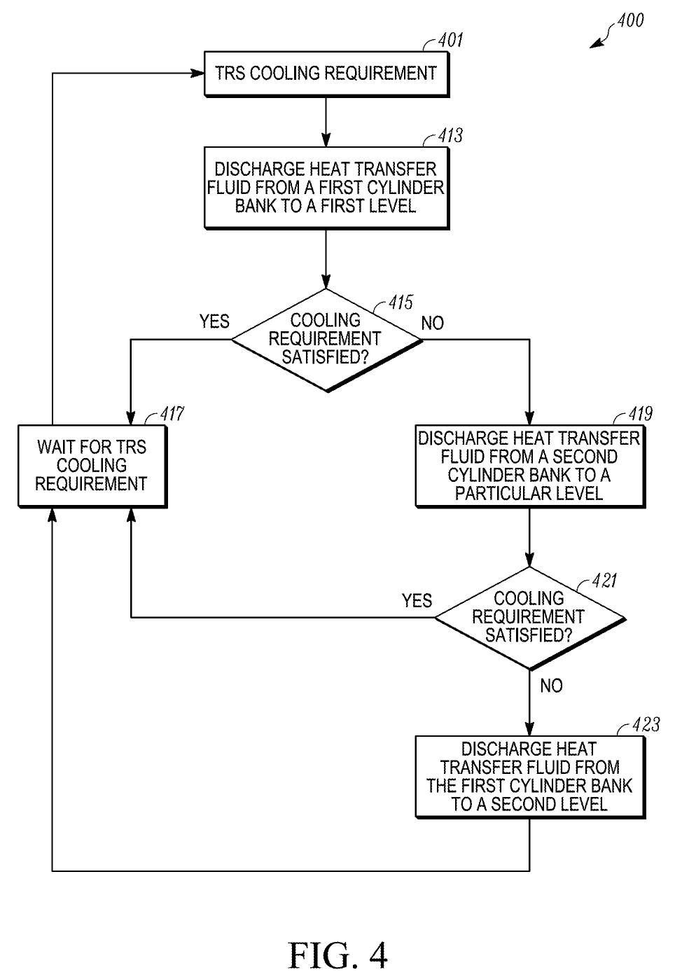

FIG. 4 illustrates a flow diagram of a method 400 for using an unloader manifold (such as, for example, the unloader manifold 204 shown in FIG. 2 and the unloader manifold 304 shown in FIG. 3) to control a discharge temperature of a heat transfer fluid discharged from a compressor (such as, for example, the compressor 202 shown in FIG. 2) in a TRS (such as, for example, the TRS 100 shown in FIG. 1), according to an embodiment.

At 411, a controller (e.g., the controller 235 shown in FIG. 2) can receive a TRS cooling requirement from the controller affiliated with the TRU (e.g., the TRU 110 shown in FIG. 1) via the controller. The cooling requirement can indicate an amount of heat transfer fluid to cool and run the system efficiently. The method 400 then proceeds to 413.

At 413, the unloader manifold discharges heat transfer fluid from a first cylinder bank (e.g., the first cylinder bank 376 shown in FIG. 3) to a first level. For example, the first cylinder bank may be discharged from 100% capacity to ˜50% capacity. The heat transfer fluid can be directed to the hot gas line (e.g., the hot gas line 256 shown in FIG. 2) via the unloader manifold. The method 400 the proceeds to 415.

At 415, the controller determines whether the cooling requirement of the TRS has been satisfied. When the controller determines that the cooling requirement has been satisfied, the method 400 proceeds to 417 whereby the controller waits to receive a TRS cooling requirement from the system. That is, the controller can receive a different or updated cooling requirement from the TRS Before the method 400 proceeds back to 400.

Alternatively, when the controller determines that the cooling requirement was not satisfied, the method 400 proceeds to 419 whereby the unloader manifold discharges heat transfer fluid from a second cylinder bank (e.g., the second cylinder bank 376 shown in FIG. 3) to a particular level. For example, in one embodiment, the second cylinder bank may be discharged from a capacity of 100% to 0%. In another embodiment, the second cylinder bank may be discharged from a capacity of ˜50% to ˜0%. That is, the second cylinder bank can be discharged to satisfy cooling requirement by providing additional heat transfer fluid to the hot gas line via the unloader manifold. The method 400 then proceeds to 421.

At 421, the controller determines whether the cooling requirement of the TRS has been satisfied. Similar to 415, when the controller determines that the cooling requirement has been satisfied, the method 400 proceeds to 417 whereby the controller waits to receive a TRS cooling requirement before the method returns to 411.

Alternatively, when the cooling requirement of the TRS has not been satisfied, the method 400 proceeds to 423 whereby the unloader manifold discharges heat transfer fluid from the first cylinder bank to a second level. For example, the first cylinder bank may be discharged from a first level (e.g., ˜50% capacity) to a second level (e.g., 0% capacity). That is, the unloader manifold can return to the first cylinder bank to discharge additional heat transfer fluid after discharging heat transfer fluid from the second cylinder bank. At 417, the controller waits to receive a TRS cooling requirement before the method returns to 411.

In some embodiments, the flow diagram can be iterative. That is, the controller can receive a TRS cooling requirement and the unloader manifold can discharge heat transfer fluid from the first and/or second cylinder(s) multiple times and/or repeatedly.

The above specification, examples, and data provide a description of the method and application, and use of the system and method in the present disclosure. Since many examples can be made without departing from the spirit and scope of the system and method of the present disclosure, this specification merely sets forth some of the many possible example configurations and implementations.

The terminology used in this Specification is intended to describe particular embodiments and is not intended to be limiting. The terms “a,” “an,” and “the” include the plural forms as well, unless clearly indicated otherwise. The terms “comprises” and/or “comprising,” when used in this Specification, indicate the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. The word “embodiment” as used within this Specification may, but does not necessarily, refer to the same embodiment. This Specification and the embodiments described are exemplary only. Other and further embodiments may be devised without departing from the basic scope thereof, with the true scope and spirit of the disclosure being indicated by the claims that follow.

### ASPECTS

It is to be appreciated that any of aspects 1-9 can be combined with any of aspects 10-14 and/or can be combined with any of aspects 15-18. Additionally, any of aspects 10-14 can be combined with any of aspects 1-9 and/or can be combined with any of aspects 15-18. Additionally, any of aspects 15-18 can be combined with any of aspects 1-9 and/or can be combined with any of aspects 10-14.

Aspect 1. A transport refrigeration system (TRS), comprising:

a heat transfer circuit, the heat transfer circuit including:
a compressor with a first cylinder bank and a second cylinder bank; and
an unloader manifold with a first end connected to the first and second cylinder bank and a second end connected to a hot gas line in the heat transfer circuit, wherein the first and second cylinder banks and the hot gas line are in fluid communication via the unloader manifold such that a heat transfer fluid can flow therethrough; and

an unloader discharge controller to unload, via the unloader manifold, heat transfer fluid from the first cylinder bank to a first discharge level.

Aspect 2. The TRS according to aspect 1, wherein the unloader discharge device unloads heat transfer fluid from the second cylinder bank to a particular discharge level after the first cylinder bank is discharged to the first discharge level.
Aspect 3. The TRS according to any one of aspects 1-2, wherein the unloader discharge device unloads heat transfer fluid from the first cylinder bank to a second discharge level after the second cylinder bank is discharged to a particular discharge level.
Aspect 4. The TRS according to any one of aspects 1-3, wherein the first discharge level is a capacity at or about 100% to 50% of heat transfer fluid, and a second discharge level is a capacity at or about 50% to 0% of heat transfer fluid.
Aspect 5. The TRS according to any one of aspects 1-4, wherein the compressor includes a check valve associated with the unloader manifold to provide durability requirements prior to unloading the heat transfer fluid.
Aspect 6. The TRS according to any one of aspects 1-5, the heat transfer circuit further includes an electronic throttling valve in an open position or a manifold tuning valve to control horsepower during particular conditions.
Aspect 7. The TRS according to any one of aspects 1-6, wherein the unloader discharge controller unloads heat transfer fluid from the second cylinder bank to a particular level and the first cylinder bank to a second level based on a cooling requirement associated with the TRS.
Aspect 8. The TRS according to any one of aspects 1-7, wherein the unloaded heat transfer fluid from the first cylinder bank flows to the hot gas line and reduces compressor power in the TRS.
Aspect 9. The TRS according to any one of aspects 1-7, wherein the first end of the unloader manifold includes a first line and a second line that connect at a manifold connection.
Aspect 10. An unloader manifold device in a transport refrigeration system (TRS), comprising:

an unloader manifold with a first end connected to the first and second cylinder bank and a second end connected to a hot gas line in the transport refrigeration system;

wherein the unloader manifold device is configured to:
discharge, based on a cooling requirement of TRS, heat transfer fluid from the first cylinder bank to a first level to cool the hot gas line;
discharge, based on a cooling requirement of the TRS, heat transfer fluid from the second cylinder bank to a particular level to cool the hot gas line after the first cylinder is discharged to the first level; and
discharge, based on a cooling requirement of the TRS, heat transfer fluid from the first cylinder bank to a second level to cool the hot gas line after the second cylinder bank is discharged to the particular level.
   Aspect 11. The unloader manifold device of aspect 10, wherein the unloader manifold eliminates a hot gas by-pass valve in the TRS.
   Aspect 12. The unloader manifold device according to any one of aspects 10-11, wherein the first cylinder bank is unloaded by use of rapid cycling during a continuous run modulation.
   Aspect 13. The unloader manifold device according to any one of aspects 10-12, wherein the compressor includes a check valve and a solenoid valve to provide durability when the first cylinder bank is unloaded.
   Aspect 14. The unloader manifold device according to any one of aspects 10-13, wherein the first end of the unloader manifold includes a first line and a second line that connect together at a manifold connection.
   Aspect 15. A method of controlling temperature using an unloader manifold in a transport refrigeration system (TRS), the method comprising:

discharging, to a first level, heat transfer fluid from a first cylinder bank associated with a compressor;

discharging heat transfer fluid from a second cylinder bank associated with the compressor after the first cylinder bank is discharged to the first level; and

directing the heat transfer fluid to a hot gas line in the transport refrigeration system.

Aspect 16. The method according to aspect 15, further comprising discharging, to a second level, heat transfer fluid from the first cylinder bank after the second cylinder bank is discharged, wherein discharging to a second level is based on a cooling requirement of the TRS.
Aspect 17. The method according to any one of aspects 15-16, wherein discharging the second cylinder bank is based on a cooling requirement associated with the TRS.
Aspect 18. The method according to any one of aspects 15-17, further comprising connecting a first line and a second line of the first end of the unloader manifold at a manifold connection.

What is claimed is:

1. A transport refrigeration system (TRS), comprising:
a heat transfer circuit, the heat transfer circuit including:
a compressor with a first cylinder bank and a second cylinder bank: and
an unloader manifold with a first end connected to the first and second cylinder bank and a second end connected to a hot gas line in the heat transfer circuit, wherein the first and second cylinder banks and the hot gas line are in fluid communication via the unloader manifold such that a heat transfer fluid can flow therethrough; and
an unloader discharge controller to unload, via the unloader manifold, heat transfer fluid from the first cylinder bank to a first discharge level.

2. The TRS according to claim 1, wherein the unloader discharge device unloads heat transfer fluid from the second cylinder bank to a particular discharge level after the first cylinder bank is discharged to the first discharge level.

3. The TRS according to claim 1, wherein the unloader discharge device unloads heat transfer fluid from the first cylinder bank to a second discharge level after the second cylinder bank is discharged to a particular discharge level.

4. The TRS according to claim 1, wherein the first discharge level is a capacity at or about 100% to 50% of heat transfer fluid, and a second discharge level is a capacity at or about 50% to 0% of heat transfer fluid.

5. The TRS according to claim 1, wherein the compressor includes a check valve associated with the unloader manifold to provide durability requirements prior to unloading the heat transfer fluid.

6. The TRS according to claim 1, the heat transfer circuit further includes an electronic throttling valve in an open position or a manifold tuning valve to control horsepower during particular conditions.

7. The TRS according to claim 1, wherein the unloader discharge controller unloads heat transfer fluid from the second cylinder bank to a particular level and the first cylinder bank to a second level based on a cooling requirement associated with the TRS.

8. The TRS according to claim 1, wherein the unloaded heat transfer fluid from the first cylinder bank flows to the hot gas line and reduces compressor power in the TRS.

9. The TRS according to claim 1, wherein the first end of the unloader manifold includes a first line and a second line that connect at a manifold connection.

10. An unloader manifold device in a transport refrigeration system (TRS), comprising:
an unloader manifold with a first end connected to the first and second cylinder bank and a second end connected to a hot gas line in the transport refrigeration system;
wherein the unloader manifold device is configured to:
discharge, based on a cooling requirement of TRS, heat transfer fluid from the first cylinder bank to a first level to cool the hot gas line;
discharge, based on a cooling requirement of the TRS, heat transfer fluid from the second cylinder bank to a particular level to cool the hot gas line after the first cylinder is discharged to the first level; and
discharge, based on a cooling requirement of the TRS, heat transfer fluid from the first cylinder bank to a second level to cool the hot gas line after the second cylinder bank is discharged to the particular level.

11. The unloader manifold device of claim 10, wherein the unloader manifold eliminates a hot gas by-pass valve in the TRS.

12. The unloader manifold device according to claim 10, wherein the first cylinder bank is unloaded by use of rapid cycling during a continuous run modulation.

13. The unloader manifold device according to claim 10, wherein the compressor includes a check valve and a solenoid valve to provide durability when the first cylinder bank is unloaded.

14. The unloader manifold device according to claim 10, wherein the first end of the unloader manifold includes a first line and a second line that connect together at a manifold connection.

15. A method of controlling temperature using an unloader manifold in a transport refrigeration system (TRS), the method comprising:
discharging, to a first level, heat transfer fluid from a first cylinder bank associated with a compressor;
discharging heat transfer fluid from a second cylinder bank associated with the compressor after the first cylinder bank is discharged to the first level; and
directing the heat transfer fluid to a hot gas line in the transport refrigeration system.

16. The method according to claim 15, further comprising discharging, to a second level, heat transfer fluid from the first cylinder bank after the second cylinder bank is discharged, wherein discharging to a second level is based on a cooling requirement of the TRS.

17. The method according to claim 15, wherein discharging the second cylinder bank is based on a cooling requirement associated with the TRS.

18. The method according to claim 15, further comprising connecting a first line and a second line of the first end of the unloader manifold at a manifold connection.
